(19) United States
(12) Patent Application Publication
(10) Pub. No.: US 2015/0301875 A1
(43) Pub. Date: Oct. 22, 2015

(54) PERSISTING AND MANAGING APPLICATION MESSAGES

(71) Applicant: Andreas Harnesk, Sandy, UT (US)

(72) Inventor: Andreas Harnesk, Sandy, UT (US)

(21) Appl. No.: 14/685,398

(22) Filed: Apr. 13, 2015

Related U.S. Application Data
(60) Provisional application No. 61/982,437, filed on Apr. 22, 2014.

(51) Int. Cl. G06F 9/54; G06F 17/30

(52) U.S. Cl. CPC G06F 9/546; G06F 17/30312

(57) ABSTRACT

Embodiments are directed to automatically persisting specified messages, to providing versioning for persisted messages and to querying persisted messages. In one scenario, a computer system establishes a repository service that is subscribed to specified types of messages, where the messages are sent from publishers to a message queue maintained by a message managing service, and where each message includes a data structure that has certain data or a certain type of data. The repository service listens for the specified types of messages to which the repository service is subscribed and receives messages of the specified type to which the repository service is subscribed. The repository service further persists at least a portion of each message received by the repository service in a data store.

### CROSS-REFERENCE TO RELATED APPLICATIONS

This application claims priority to and the benefit of U.S. Provisional Patent Application Ser. No. 61/982,437, entitled “Persisting and Managing Application Messages”, filed on Apr. 22, 2014, which application is incorporated by reference herein in its entirety.

### BRIEF SUMMARY

Embodiments described herein are directed to automatically persisting specified messages, to providing versioning for persisted messages and to querying persisted messages that can contain substantially any type of data. In one embodiment, a computer system establishes a repository service that is subscribed to specified types of messages, where the messages are sent from publishers to a message queue maintained by a message managing service, and where each message includes a data structure that has certain data or a certain type of data. The repository service accesses a message feed from at least one publisher to listen for the specified types of messages to which the repository service is subscribed and receives messages of the specified type to which the repository service is subscribed. The repository service further persists at least a portion of each message received by the repository service in a data store.

This automatic persisting of specified messages may reduce a user's manual involvement in selecting which messages are important. Moreover, because the messages are intercepted and stored without the sender's knowledge, the message sender does not need to be notified or altered to facilitate the automatic persisting of specified messages as described in relation to method 200. This conserves memory and preserves processor load that would otherwise have been used to send separate messages to the intercepting entity, thereby avoiding duplication of effort.

In another embodiment, a computer system receives messages to which a repository service is subscribed, where the messages are received from various message publishers. Each message is a data structure that includes message data identified by an entity ID. The computer system determines that a portion of message data having the same entity ID as the received message data is already stored at a data store accessible to the repository service. The computer system determines that the stored message data has been assigned a timestamp and corresponding version information, and creates a new data store entry for the stored message data, where the new data store entry has the same entity ID and updated version information and timestamp, so that multiple entities with the same entity ID are created in the data store. The versioning of persisted messages allows actions to be replayed at any point in a given timeline. This increases security and reliability in the processes described herein, as each user's actions are identifiable and reversible if needed

In yet another embodiment, a computer system receives, an indication that a query is to be generated to query against data stored on a data store. The indication provides a context for the query that is to be generated. The computer system determines that the context specifies various characteristics of the data that are to be returned based on the query, and further translates the specified characteristics into a data query that is understandable by the data store. The data store's underlying query language is abstracted to the user, so that user queries are generated based on data characteristics provided by the user. The computer system then generates the data query according to the translated characteristics and sends the generated query to the data store for processing by the data store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including automatically persisting specified messages.

FIG. 2 illustrates a flowchart of an example method for automatically persisting specified messages.

FIG. 3 illustrates a flowchart of an example method for providing versioning for persisted messages.

FIG. 4 illustrates a flowchart of an example method for querying persisted messages.

FIG. 5 illustrates an embodiment in which persisted messages are versioned.

### DETAILED DESCRIPTION

Embodiments described herein are directed to automatically persisting specified messages, to providing versioning for persisted messages and to querying persisted messages that can contain substantially any type of data. In one embodiment, a computer system establishes a repository service that is subscribed to specified types of messages, where the messages are sent from publishers to a message queue maintained by a message managing service, and where each message includes a data structure that has certain data or a certain type of data. The repository service accesses a message feed from at least one publisher to listen for the specified types of messages to which the repository service is subscribed and receives messages of the specified type to which the repository service is subscribed. The repository service further persists at least a portion of each message received by the repository service in a data store.

In another embodiment, a computer system receives messages to which a repository service is subscribed, where the messages are received from various message publishers. Each message is a data structure that includes message data identified by an entity ID. The computer system determines that a portion of message data having the same entity ID as the received message data is already stored at a data store accessible to the repository service. The computer system determines that the stored message data has been assigned a timestamp and corresponding version information, and creates a new data store entry for the stored message data, where the new data store entry has the same entity ID and updated version information and timestamp, so that multiple entities with the same entity ID are created in the data store.

In yet another embodiment, a computer system receives, an indication that a query is to be generated to query against data stored on a data store. The indication provides a context for the query that is to be generated. The computer system determines that the context specifies various characteristics of the data that are to be returned based on the query, and further translates the specified characteristics into a data query that is understandable by the data store. The data store's underlying query language is abstracted to the user, so that user queries are generated based on data characteristics provided by the user. The computer system then generates the data query according to the translated characteristics and sends the generated query to the data store for processing by the data store.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

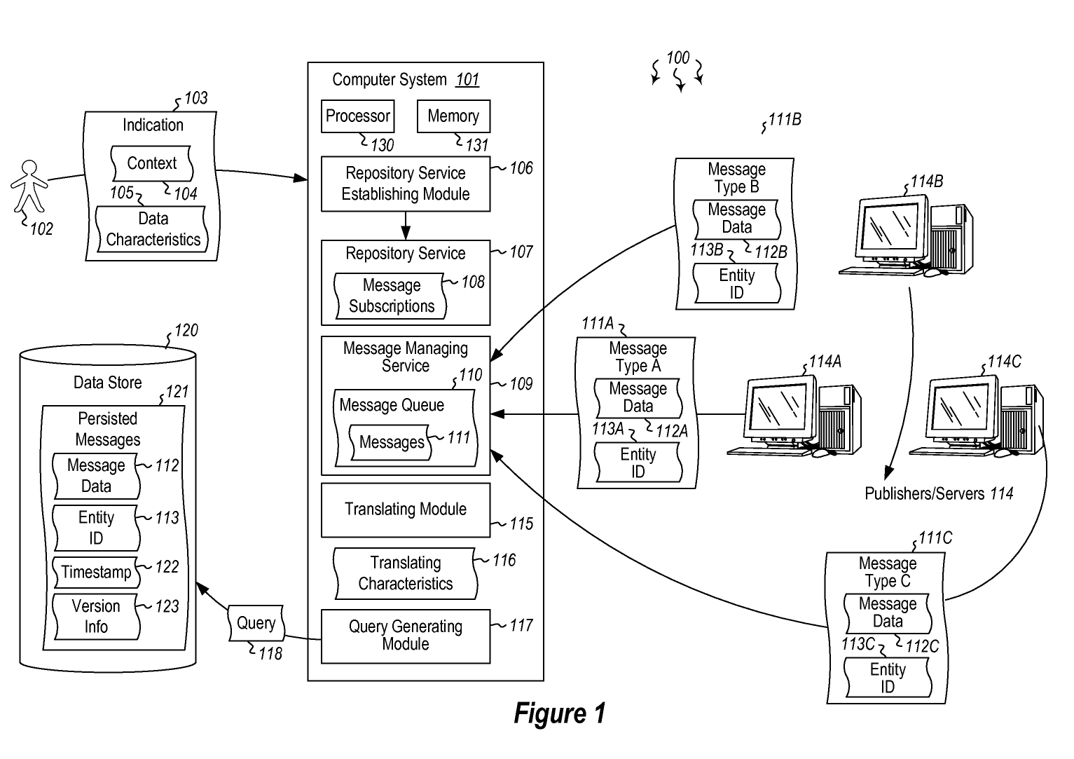

As illustrated in FIG. 1, a computing system 101 typically includes at least one processing unit 130 and memory 131. The memory 131 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product. An example of such an operation involves the manipulation of data. The computer-executable instructions (and the manipulated data) may be stored in the memory 131 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 131. The system memory may also be referred to as “main memory”, and includes memory locations that are addressable by the at least one processing unit 130 over a memory bus in which case the address location is asserted on the memory bus itself. System memory has been traditionally volatile, but the principles described herein also apply in circumstances in which the system memory is partially, or even fully, non-volatile.

Embodiments described herein also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, embodiments described herein may comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the embodiments described herein.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system includes modules for performing a variety of different functions. For instance, computer system 101 includes repository service establishing module 106 which is configured to establish or instantiate repository service 107. The repository service is a software service that stores messages in a data store (e.g. 120). The repository service may receive (or intercept) messages to which it is subscribed (e.g. via message subscriptions 108), and may send those messages to the data store 120. The data store may be any type of local or distributed (e.g. cloud-based) data store, including a hard disk or an array of such. The data store (or parts thereof) may also be virtualized on virtual machines. As such, the messages persisted by the repository service 107 (i.e. persisted messages 121) may be stored in a single (local or remote) location, or across multiple machines in a distributed manner.

The persisted messages 121 may include a variety of different information, including the message data 112 (which is the contents of the message sent by the publisher, service or application 114), an entity identifier 113, a timestamp 122 to show its time of creation or last update, and version information which indicates the message's version history. These messages may be sent by various publishers including services or applications. The messages (e.g. 111A, 111B or 111C) may be any type of message, including those messages that are normally sent between services and applications. The messages may indicate that certain events have occurred (or have not occurred), that certain processes have started, stopped, returned an error code, etc., or may communicate other steps in a process. Many different types of messages are possible, including message types A (111A), B (111B) and/or C (111C). Of course, substantially any number of message types may be used, and messages from any type of publisher including services and applications may be received and persisted by computer system 101. Each message published by the publishers 114A-C may include information including message data 112A-C for each message and an entity ID 113A-C for each message that identifies that specific message.

These messages may be received by or intercepted by message managing service 109. The message managing service maintains a message queue 110 with one or more messages 111 published by publishers 114. These messages may be organized in a queue 110 which is accessible by the repository service 107. The repository service may then access or receive from the queue those messages to which it is subscribed (via subscriptions 108). These messages may then be persisted on data store 120. As such, each application, service or other publisher may have its messages automatically persisted without knowing that its messages are being persisted, or without sending special messages to indicate that its messages (or a subset thereof) are to be persisted.

This automatic persistence may be performed in multiple different ways. For instance, the data contained in a message may be persisted in its entirety, and any future messages would replace the prior messages entirely (“replace” mode). In another mode, only the message data (e.g. 112) is persisted, while the rest of the message remains in place (“update-in-place” mode). In replace mode, a single entity ID 113 used by the repository service would be associated with the complete set of application data for that message, but in update-in-place mode, each piece of application data would be associated with its own entity ID. The determination as to which mode to use may be decided by each individual service, and each service might use a different pattern. This allow for a service to trade-off simplicity for speed. For example, sending all the current data in a message is simpler but might not be practical when the size of the data grows too large.

In some embodiments, automatic persistence of messages is enabled by a setup procedure. In the setup procedure, services send a persistence definition to the repository service. This definition will specify which business messages should be persisted. This definition is part of (or itself comprises) the message subscriptions 108. When messages sent or received by the message managing service 109 match a given persistence definition, the repository service will persist the message data of those messages. For example, messages sent by publisher 114A can be registered for pickup (i.e. subscribed to) in the repository service 107. Whenever a message is sent by a publisher, it will be picked up by the repository service and added to or updated in the data store 120. Using this setup method will enable a developer to only focus on persistence one time (i.e. at persistence registration time). The automatic persistence of messages will be completely transparent to the developer since he or she will only pass normal, business messages.

At startup of an application or service, the developer may register the messages that are to be persisted. This setup procedure, which includes providing a persistence definition of what messages should be automatically persisted (i.e. a subscription 108), could be done both in runtime by sending a specified registration message. The definition may also be provided offline, where the registration or subscription data is read at start up (or when the configuration changes) by the repository service. If desired, the repository service can send a confirmation message that the registration of the definition was successful.

After this setup procedure is completed, when a message is sent over the wire, e.g. when the user interface sends data for new article creation to the backend, these messages are (if registered) picked up by the repository service, and the new data is transparently added to the data store.

As mentioned above, each message may be of a specific message type (e.g. 111A-C). The “data structure” or “schema” of a message type can be defined during registration. The schema may be used to specify required values. If the repository service receives a message of the same type that doesn't match the schema, the data is not saved and an error message is published. If however, the message contains more properties than just the ones specified by the schema, the data will be saved successfully. For example, if a schema specifies that the data should contain stock-keeping unit number (SKU#), Length, Width and Height and a message containing SKU#, Length, Width and Quantity is received, an error message will be published indicating that the message was not saved because the schema did not match. For a message containing Length, Width, Height, Quantity and SKU#, the data will be saved because the schema does match. At least in some embodiments, the schema may be optional and, in such cases, if no schema is supplied during registration, any data will be valid and will be saved.

The persistence definition contains a mapping of which types of messages and of which message topics that should be persisted when passed or otherwise managed by the message managing service 109. When the repository service receives a message of the registered/subscribed type on the specified topic, the repository service will store the values of the message with a context corresponding to the topic of the actual message.

Even though the persistence of the message data is handled transparently, the developer of the business logic may provide a context of the data (i.e. an indication of what the data is about). This functionality enables the persistence service to store the same type of data but for different contexts. For example if a business developer sends a message with a type of “article” and a context of “articles.customer-a.site-a”, and this type has been registered for persistence, the data (articles in this case) will be stored at the “location” of “articles.customer-a.site-a”. When another service sends a business message with the context of “articles.customer-a.site-b” then there will be no clash between the contexts. Moreover, the data store 120 can contain articles mapped to different contexts (customer sites in the above example).

At least in some embodiments, contexts may have no relations to each other, so that “articles.customer-a.site-a” and “articles.customer-a.site-b”, while appearing like two paths down the same tree, the paths are considered two completely separate entities and have no relation to each other, other than any relation interpreted or intended by the developer of the business logic that uses the persistence service. Context and its corresponding data can be considered as a key/value relationship. To keep track of what is stored, the repository service may add an entity ID (e.g. 113A) to every piece of business/message data that is stored. Incoming entities that do not have an entity ID may be assigned one by the repository service. These IDs can also be used in a message delete operation.

In addition to the entity ID, the developer (or other user) can specify one or more properties as being unique. For example, a SKU# is most likely interpreted as a unique business ID. Instead of having the application developer keeping track of the unique business IDs, the repository service will do that for us. If a new entity (no or different entity ID 113) is received by the repository service with an already existing business ID, the data is ignored and an error message is published. The unique business ID is an optional parameter in the registration phase. In some case, identical business IDs with different entity IDs may be allowed to exist in different contexts. In the example above, both site a and site b can have an entity with the same SKU# but different other properties.

The repository service 107 can also be configured to keep track of all versions of an entity (i.e. a message). By tracking the version of each message, an end user that can revert changes done by mistake, even weeks (or longer) after the changes have been made. The version history may also be used by a developer during debugging. If all entity versions are stored, the database can be used to replay the steps that led up to a failure. Whenever an entity is changed, a new entry in the database is created with the new data 112, an increased revision number 123 and a timestamp 122 indicating when the change occurred. This will create multiple entities with the same ID in the database. However, at least in some cases, queries to the database will only return the entity as of the latest point in time, unless specified otherwise in the query. The other entities will be in an archived state.

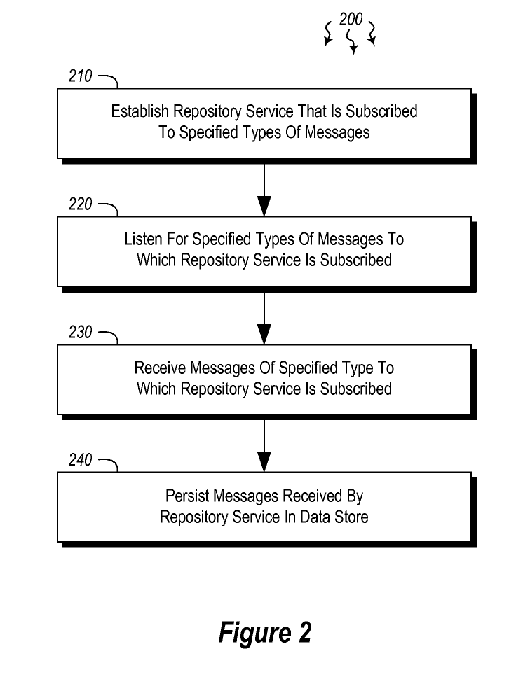

To get full audit capabilities, i.e. to replay steps of the system, not only the entities representing the data of the system are to be persisted, but also the messages sent and an indication of who sent the messages is also to be persisted. The versions of the data entities can answer the question of “what has happened” and the messages can answer the question of “why did something happen” and “who did what”. By using a definition that only contains a type and no context, messages of that type can be configured to be implicitly stored. Since the topic in the definition/subscription, a context can still be provided on each individual message on that message managing service subscription 108. For example, if a definition is configured with a type of “log” and an empty topic, the repository service 107 would listen to all broker messages on the topic of “log”, meaning all messages with a topic that begins with “log”. When an application service then sends a message of type “log” and a topic/context of “articles-service.log”, that message will be picked up (since the type matches) and its data will be persisted in the “articles-service.log” context. These concepts will be explained further below with regard to methods 200, 300 and 400 of FIGS. 2, 3 and 4, respectively.

In view of the systems and architectures described above, methodologies that may be implemented in accordance with the disclosed subject matter will be better appreciated with reference to the flow charts of FIGS. 2, 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for automatically persisting specified messages. The method 200 will now be described with frequent reference to the components and data of environment 100.

Method 200 includes establishing a repository service that is subscribed to one or more specified types of messages, the messages being sent from publishers to a message queue maintained by a message managing service, each message comprising a data structure that has certain data or a certain type of data (210). For example, repository service establishing module 106 may establish repository service 107. The repository service 107 is subscribed to (or is registered for) specified types of messages, including types 111A-C. These messages are sent from any of publishers 114A-C or other publishers not shown. The messages may be data structures or may include data structures that themselves contain specified data or are of a certain data type. The data structures may include primitive types (e.g. character, double, floating-point), composite types (e.g. array, record, union, etc.), abstract data types (e.g. container, list, set, stack, tree, etc.), hashes, graphs or any other types of data structures. Thus, for example, the repository service 107 may subscribe to messages that have data or content related to a particular job, or may subscribe to messages of a particular type, such as “order request” messages.

The repository service 107 stores data for a multiple different applications in the data store 120. In this manner, each application does not have to provide its own persistent storage, and developers of applications do not need to code for such persistence. Indeed, at least in some cases, the developers and/or the applications themselves may be unaware of or may not need to have detailed (or any) information indicating where the messages are to be sent for persistent storage or may not have any indication that messages are being stored at all.

Method 200 includes the repository service accessing a message feed from at least one publisher to listen for the specified types of messages to which the repository service is subscribed (220). For example, if the repository service 107 is subscribed to receive messages of types 111B and 111C, the repository service will monitor a message feed such as message queue 110 for those types of messages, as they are published by the respective publishers 114B and 114C. The repository service then receives one or more messages of the specified type to which the repository service is subscribed (230). These messages (or at least a portion thereof) are then automatically persisted in the data store (240). In this manner, the repository service 107 subscribes for and receives business messages from a plurality of different applications or services, and automatically persists those messages in a data store.

In some cases, the repository service itself may be configured to publish data upon receiving data requests. For instance, a user (e.g. 102) may be able to query the repository service for certain information (regarding a subscription, for example), and the repository service may publish the requested information for the user. The user may, in some instances, send updated subscription data, indicating that the repository service is now subscribed to at least one additional type of message (e.g. message type 111A in the example above, in addition to types 111B and 111C). Upon receiving this updated subscription data, the repository service 107 may automatically persist messages for the new type specified in the subscription update.

As mentioned above, the contents of each message may be persisted as a single entity in “replace” mode. In this mode, any previous versions of the entity are overwritten and replaced with the new entity. Each entity may have its own unique entity identifier 113. In “update-in-place” mode, only a portion of the message previously stored in the data store is replaced. As such, in replace mode, if a message has message content with four items, and the previous corresponding message had five items (e.g. five settings in a settings file), the new file with four items would be stored. Conversely, in update-in-place mode, if you start with five items, and four items are in the new message, the four items will be updated within the entity, and the fifth item will remain from the previously stored message. If the fifth item is to be deleted, it is manually deleted.

The repository service may be further configured to track entity versions of a message in a revision history. The revision history may include indications of what changed within the entity, who changed the entity and when the entity was changed. The revision history may further include one or more timestamps, and may indicate what happened at each timestamp. This may allow users to replay what has occurred over a specified period of time. For instance, a user may be able to step through the messages sent by one or more applications or services before a system crash to determine (potentially) how the crash occurred.

In some cases, a single entity ID may be stored multiple times within the data store. When requested in a query, however, the latest version of the entity will be returned. In cases where a message is received that does not have an entity ID, an entity ID will automatically be applied and associated with that message. Furthermore, while an entity ID may be assigned to an entire message, it should also be noted that an entity ID may be assigned to each portion of message content in a message. Thus, a single message may have multiple different entity IDs corresponding to different parts of the message.

In some cases, a specified portion of message content may be assigned a unique business ID in addition to the entity ID. The unique business ID uniquely identifies the specified portion of message content. The business ID itself may belong to a specified context, where each context has one or more business IDs. For instance, the repository service 107 may determine a context for a message, and that context may have multiple business IDs associated with it. The repository service may determine context for each message based on the message's content, or based on other criteria. The context may include a specific data structure or schema type for a message.

Thus, as mentioned above, the repository service may register to receive messages having a specified data structure or schema type such as SKU#, Length, Width and Height. If the message does not have that schema type, it will not be stored, and/or an error message will be sent, or some other action will occur. Messages persisted by the repository service may be deleted by authorized users, but at least in some embodiments, those messages are not fully deleted, and remain persisted in the data store 120. Incoming requests for these data items may, however, be answered with an indication that the deleted messages are unavailable. The data, however, is kept in the repository at least for version history reasons.

In this manner, automatic persisting of specified messages may reduce a user's manual involvement in selecting which messages are important. Moreover, because the messages are intercepted and stored without the sender's knowledge, the message sender does not need to be notified or altered to facilitate the automatic persisting of specified messages as described in relation to method 200. This conserves memory and preserves processor load that would otherwise have been used to send separate messages to the intercepting entity, thereby avoiding duplication of effort.

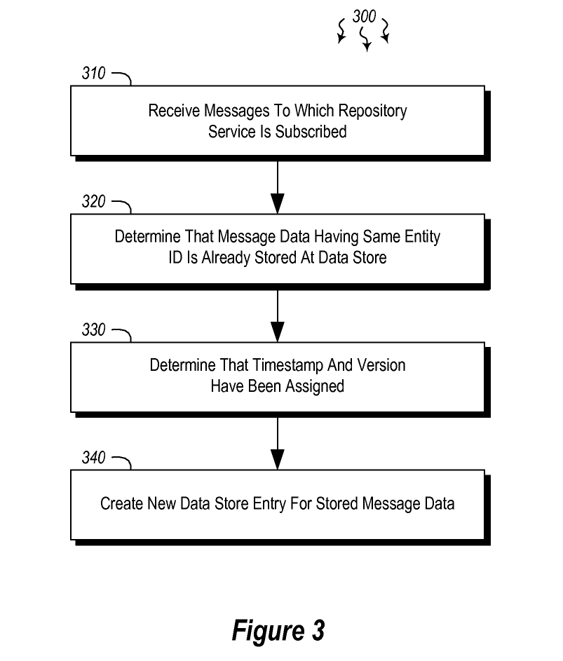

Turning now to FIG. 3, a flowchart is illustrated of a method 300 for providing versioning for persisted messages. The method 300 will now be described with frequent reference to the components and data of environment 100.

Method 300 includes receiving, at a repository service, one or more messages to which the repository service is subscribed, the messages being received from one or more message publishers, the messages comprising data structures that include message data identified by an entity ID (310). For example, repository service 107 may receive any of messages 111A-C received from publishers 114A-C. Each message includes corresponding message data 112A-C and a unique entity ID 113A-C, respectively. The repository service may determine that a portion of message data having the same entity ID as the received message data is already stored at a data store accessible to the repository service (320). Thus, for instance, the repository service may receive a message that has an entity ID 113A, and may have already persisted a message in data store 120 that has entity ID 113A.

The repository service 107 then determines that the stored message data 112 (for persisted message 121) has been assigned a timestamp 122 and corresponding version information 123 (330). The repository service 107 may then create a new data store entry for the stored message data, where the new data store entry has the same entity ID and updated version information and timestamp (340). As such, multiple entities can have the same entity ID within the data store (340).

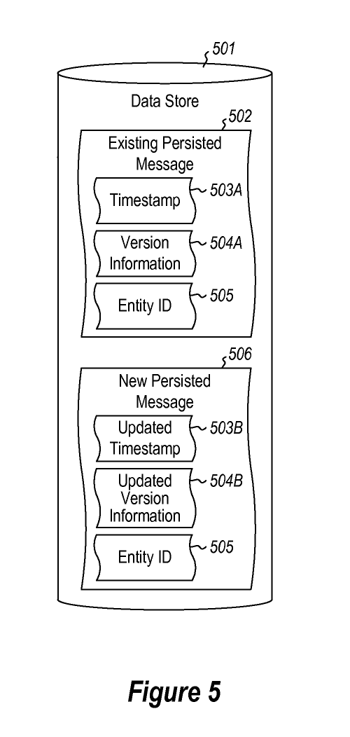

FIG. 5 illustrates such an embodiment. Indeed, the data store 501 (which may be the same as or different than data store 120) has at least one existing persisted message 502, with a corresponding timestamp 503A, version information 504A and a unique entity ID 505. The repository service 107 may receive a message with the same unique entity ID, and may create a new persisted message 506 that has an updated timestamp 503B and updated version information 504B. The new persisted message 506, however has the same unique entity ID 505. As such, the data store 501 can store multiple messages with the same unique entity ID. Those messages, however, will have a different timestamp and version information. In this manner, the data store can store multiple versions of the same message.

The repository service 107 and/or the data store 120 may track certain types of information when recording different versions of a message. The tracked information may include indications of what message data has changed, which entity made the changes, when the changes were made, and other information. By storing different versions of the persisted messages (e.g. 121), users may be able to revert specific changes including those made at a specific time, or by a specific user, or to a specific message, or some combination thereof. Storing different versions of messages also allows users to replay certain changes, including those made by specific people perhaps at specified times. Accordingly, the versioned messages allow users to see what has been changed, when it was changed and who changed it, over a given period of time. When data store entities (i.e. messages) are changed, the data store entries for those messages are also updated to reflect the changes. The versioning of persisted messages thus allows actions to be replayed at any point in a given timeline, which increases security and reliability, as each user's actions are identifiable and reversible when needed.

It should also be noted that persisted messages (e.g. 121) may be queried by users, services, applications or other entities. To query data from the data store 120, a service sends a query message. The query message contains the context 104 for which the data should be fetched and an optional query string. The query string may include data characteristics for the data that is to be fetched, and can be used to filter any data that should not be returned to the service performing the query. For example given a context of “articles.company-a.site-a” and a filter with the property “name” set to “ab”, any articles included in the context that have a name containing “ab” would be included. The query could also support simple comparison operations such as >, < and =.

The query can also specify a chunk size and which chunk to return. This allows a subset of the data to be fetched that matches the given query. In a query result, the repository service 107 can include the total count of the entities that match the query to give the user or other entity the ability to know how much more data there is to fetch. The query could further include a list of the fields that should be included in the reply. In one scenario, all the data would be returned (for example “length” “width” and “height”) but by the query only a sub-set could be selected to be included in the data returned (for example only “length”). Message data returned in response to a query may be accompanied by its entity ID, thus allowing application developers to perform operations on the entity level (e.g. perform a delete operation).

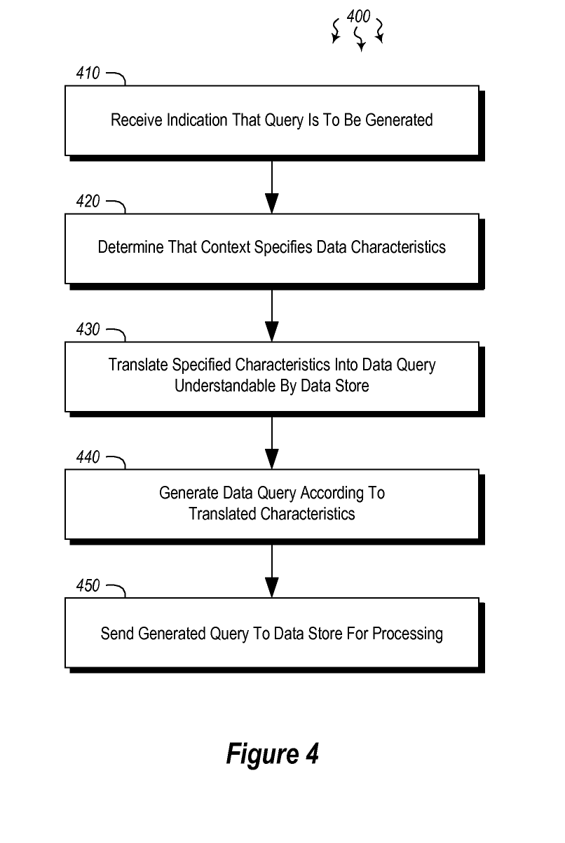

By adding a very lightweight query language, the actual query language used by the data store 120 may be abstracted away. This allows different storage databases to be used by the repository service 107 without the need of any business services to know about the change of databases, and no (or very few) steps will need to be performed to adapt to the changed database. The lightweight query language also allows the repository service to store data on several different types of data stores and to different database locations, transparent to the service or application. If a service or application needs more query power than is provided by the lightweight query language, the service or application may connect to and directly query the data store, or send a “raw” query string to the persistence service to run. These concepts will be explained further below with regard to method 400 of FIG. 4.

FIG. 4 illustrates a flowchart of a method 400 for querying persisted messages. The method 400 will now be described with frequent reference to the components and data of environment 100.

Method 400 includes receiving, from a user, an indication that a query is to be generated to query against data stored on a data store, the indication providing a context for the query that is to be generated (410). For example, repository service 107 may receive indication 103 from user 102 (or from another entity such as a service or application) indicating that a query is to be generated to query against message data 112 stored on data store 120. The indication from the user or other entity provides a context 104 for the query that is to be generated. Method 400 includes determining that the context specifies one or more characteristics of the data that are to be returned based on the query (420), and translates the specified characteristics into a data query 118 that is understandable by the data store, the data store's underlying query language being abstracted to the user, such that user queries are generated based on data characteristics provided by the user (430).

Thus, the translating module 115 may translate the data characteristics 105 provided by the user in the indication 103. The translation translates the data characteristics provide by the user into a data query that is understandable by the data store 120. Thus, if the data store is of a given type, the query is created in the format or language used by that type of data store. The user or other entity need only provide the desired data characteristics and the translation module 115 performs the translating to data-store-understandable query language. The query generating module 117 then generates the data query 118 according to the translated characteristics 116 (440). This query is then sent to the data store for processing by the data store (450).

Once the data store has finished processing the query 118, any results from the query are sent to the user or other entity that requested the query. Thus, if user 102 used computer system 101 to submit their query request with context 104 and data characteristics 105, the results of the query would be sent back to computer system 101 for presentation to the user 102. In some cases, the indication is provided in a language that is different than the query language used by the repository service. The translation module 115 may be configured to receive query indications in a variety of different languages or formats, and translate them to be compatible with the data store 120. Queries for specified messages may return the latest entity (according to timestamp of last update), unless the query indicates that a message from a different time is to be returned. Queries to receive all versions of an entity within a specified timespan may also be implemented. In such cases, the query would just specify a timespan and those entities within the timespan would be returned.

The generated query may further include an indication of one or more fields that are to be included in the query reply. These fields may be populated by the data store when providing the query results. Once the query has been processed, the data store 120 or the computer system 101 may send a notification message indicating that the query was successfully processed; or, alternatively, if the query processing was unsuccessful, may send an error message indicating that an occurred and that the query was not processed. In this manner, users or other entities may be able to query data store persisted messages without having to understand or even know query formats or protocols for that data store. Rather, the user may be able to provide context and desired data characteristics, and the system will perform any necessary translation, generate the query and send it to the data store for processing. The user can then receive the results of their query in a timely fashion.

Accordingly, methods, systems and computer program products are provided which automatically persist specified messages. Moreover, methods, systems and computer program products are provided which provide versioning for persisted messages and query persisted messages.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

I claim:

1. A computer system comprising the following:
one or more processors;
system memory;
one or more computer-readable storage media having stored thereon computer-executable instructions that, when executed by the one or more processors, causes the computing system to perform a method for automatically persisting specified messages, the method comprising the following:
establishing a repository service that is subscribed to one or more specified types of messages, the messages being sent from publishers to a message queue maintained by a message managing service, each message comprising a data structure that includes certain data or a certain data type;
the repository service accessing a message feed from at least one publisher to listen for the specified types of messages to which the repository service is subscribed;
the repository service receiving one or more messages of the specified type to which the repository service is subscribed; and
the repository service automatically persisting at least a portion of each message received by the repository service in a data store.

2. The computer system of claim 1, wherein the repository service is configured to publish data upon receiving data requests.

3. The computer system of claim 1, further comprising:
receiving updated subscription data, indicating that the repository service is subscribed to at least one additional type of message; and
automatically persisting the messages of the type specified in the subscription update.

4. The computer system of claim 1, wherein the repository service stores data for a plurality of different applications in the data store.

5. The computer system of claim 1, wherein message publishers are unaware of where the messages are to be sent for persistent storage.

6. The computer system of claim 1, wherein the contents of the messages are persisted as a single entity, replacing previous versions of the entity, each entity having its own unique entity identifier.

7. The computer system of claim 6, wherein the repository service tracks entity versions in a revision history, including tracking at least one of the following: what changed, who changed the entity and when the entity was changed.

8. The computer system of claim 7, further comprising accessing the revision history including one or more timestamps to replay what has occurred over a specified period of time.

9. The computer system of claim 1, wherein a subset of the contents of the messages is persisted in the data store, such that persisted messages are updated in place.

10. The computer system of claim 9, wherein each subset of message content is assigned its own unique entity identifier.

11. The computer system of claim 9, wherein at least one specified portion of message content is assigned a unique business identifier in addition to the entity identifier, the unique business identifier uniquely identifying the specified portion of message content.

12. The computer system of claim 11, wherein the business identifier belongs to a specified context, each context having one or more business identifiers.

13. The computer system of claim 1, wherein the repository service registers to receive messages having a specified data structure or schema type.

14. The computer system of claim 1, wherein the repository service determines context for each message based on the message's content.

15. The computer system of claim 1, further comprising retaining automatically persisted messages even upon deletion, wherein requests for deleted items are answered with an indication that the deleted messages are unavailable.

16. At a computer system including at least one processor, a computer-implemented method for providing versioning for persisted messages, the method comprising the following:
receiving, at a repository service, one or more messages to which the repository service is subscribed, the messages being received from one or more message publishers, the messages comprising data structures that include message data identified by an entity ID;
determining that a portion of message data having the same entity ID as the received message data is already stored at a data store accessible to the repository service;
determining that the stored message data has been assigned a timestamp and corresponding version information; and
creating a new data store entry for the stored message data, the new data store entry having the same entity ID and updated version information and timestamp, such that multiple entities with the same entity ID are created in the data store.

17. The computer-implemented method of claim 16, further comprising recording one or more versions of the messages including tracking at least one of the following: what message data has changed, which entity made the changes, and when the changes were made.

18. The computer-implemented method of claim 17, wherein the message versions allow users to revert specified changes made by specified persons at specified times.

19. The computer-implemented method of claim 17, wherein the message versions allow users to replay specified changes made by specified persons at specified times.

20. The computer-implemented method of claim 16, wherein each message is assigned a unique identifier for storage in the data store.

21. The computer-implemented method of claim 20, wherein a new data store entry is changed for a message upon determining that the entity has changed in some manner.

22. The computer-implemented method of claim 16, wherein data store queries for specified messages return the latest entity, unless the query specifies a different time.

23. A computer program product for implementing a method for querying persisted messages, the computer program product comprising one or more computer-readable storage media having stored thereon computer-executable instructions that, when executed by one or more processors of a computing system, cause the computing system to perform the method, the method comprising:
receiving an indication that a query is to be generated to query against data stored on a data store, the indication providing a context for the query that is to be generated;
determining that the context specifies one or more characteristics of the data that are to be returned based on the query;
translating the specified characteristics into a data query that is understandable by the data store, the data store's underlying query language being abstracted to a user, such that user queries are generated based on data characteristics provided by the user;
generating the data query according to the translated characteristics; and
sending the generated query to the data store for processing by the data store.

24. The computer program product of claim 23, further comprising receiving and presenting the query response on the computer system.

25. The computer program product of claim 23, wherein the indication is provided in a language that is different than the query language used by the repository service.

26. The computer program product of claim 23, wherein the generated query includes an indication of one or more fields that are to be included in the query reply.

27. The computer program product of claim 23, further comprising sending a notification message indicating that the query was successfully processed or that an error occurred and that the query was not processed.

28. At a computer system including at least one processor, a computer-implemented method for automatically persisting specified messages, the method comprising the following:
establishing a repository service that is subscribed to one or more specified types of messages, the messages being sent from publishers to a message queue maintained by a message managing service;
the repository service listening for the specified types of messages to which the repository service is subscribed;
the repository service receiving one or more messages of the specified type to which the repository service is subscribed; and
the repository service automatically persisting at least a portion of each message received by the repository service in a data store.

29. A computer system comprising the following:
one or more processors;
system memory;
one or more computer-readable storage media having stored thereon computer-executable instructions that, when executed by the one or more processors, causes the computing system to perform a method for providing versioning for persisted messages, the method comprising the following:
receiving, at a repository service, one or more messages to which the repository service is subscribed, the messages being received from one or more message publishers, the messages including message data identified by an entity ID;
determining that a portion of message data having the same entity ID as the received message data is already stored at a data store accessible to the repository service;
determining that the stored message data has been assigned a timestamp and corresponding version information; and
creating a new data store entry for the stored message data, the new data store entry having the same entity ID and updated version information and timestamp, such that multiple entities with the same entity ID are created in the data store.

30. At a computer system including at least one processor, a computer-implemented method for querying persisted messages, the method comprising the following:
receiving an indication that a query is to be generated to query against data stored on a data store, the indication providing a context for the query that is to be generated;
determining that the context specifies one or more characteristics of the data that are to be returned based on the query;
translating the specified characteristics into a data query that is understandable by the data store, the data store's underlying query language being abstracted to a user, such that user queries are generated based on data characteristics provided by the user;
generating the data query according to the translated characteristics; and
sending the generated query to the data store for processing by the data store.
